(19) United States
(12) Patent Application Publication
(10) Pub. No.: US 2024/0155735 A1
(43) Pub. Date: May 9, 2024

(54) Establishing a Data Connection With an Emergency Control Center Via a RAN

(71) Applicant: Telefonaktiebolaget LM Ericsson (PUBL), Stockholm (SE)

(72) Inventors: Edgar Ramos, KIRKKONUMMI (FI); Jaime Jiménez, ESPOO (FI)

(21) Appl. No.: 18/550,511

(22) PCT Filed: Mar. 16, 2021
(86) PCT No.: PCT/EP2021/056637

§ 371 Date: Sep. 14, 2023

(51) Int. Cl. H04W 76/50; H04W 4/90

(52) U.S. Cl. CPC H04W 76/50; H04W 4/90

(57) ABSTRACT

Computing devices and Methods for establishing a data connection with an emergency control centre via a RAN are provided. A computing device operable to establish a data connection with an emergency control centre via a RAN includes processing circuitry operable to detect (S102) sensor data indicative of an emergency situation, and initiate (S104) transmission of an access request, requesting establishment of a connection, to a RAN node of the RAN. The computing device is further operable to, in response to a received (S106) notification of an established connection, initiate (S108) transmission of an attach request, requesting establishment of a data connection with an emergency control centre. The attach request includes an indicator that the attach request relates to the emergency situation.

### TECHNICAL FIELD

The present disclosure relates to a computing device operable to establish a data connection with an emergency control centre via a Radio Access Network (RAN), a method in a computing device for establishing a data connection with an emergency control centre via a RAN, a corresponding computer program, a corresponding carrier, and a corresponding computer program product.

### BACKGROUND

The use of general emergency numbers to contact emergency services is common around the world. Examples of general emergency numbers include the UK 999 number, the European 112 number and the US 911 number; all of these example emergency numbers are used to contact emergency services (typically a central dispatcher able to dispatch the services required for a particular emergency) using voice communication. There is currently no equivalent common procedure for contacting emergency services using data communication.

The European Emergency Number Association (EENA) has created a set of guidelines considering the use of data communications in emergency situations (“Public Safety Digital Transformation: The Internet of Things (IoT) and Emergency Services v1.05, available at https://eena.org/knowledge-hub/documents/the-internet-of-things-and-emergency-services/ as of 26 Feb. 2021). The configuration envisaged in the guidelines requires the use of gateways, and treats sensor data as metadata to be added to a Session Initiation Protocol (SIP) emergency call. In particular, the guidelines propose the use of a “sending gateway element” as an intermediary to the communication and an “application framework” used to: “evaluate the sensor's data and to lift it into the operational context (command and control procedures layer), for monitoring purposes, resulting activity, or remote control between receiving application and sending sensor or any other component that can influence the status of the system” (see section 4.1 of the guidelines on page 8).

A mechanism that indicates to the network an emergency context of communication is not in place for data-initiated sessions; data-initiated sessions are sessions initially using a data transmission, as opposed to voice sessions such as those that may be used in 2^{nd} Generation (2G) Global System for Mobile Communications (GSM) networks, 3^{rd} Generation (3G) Universal Mobile Telecommunications System (UMTS) networks or circuit-switched telephone networks. Data initiated sessions may be used by devices such as IoT devices. The term “Internet of Things” (IoT) is used to refer to devices, which may include computing devices such as digital machines or mechanical devices, that are enabled for communication network connectivity. Communication network connectivity allows IoT devices to be remotely managed, and data collected or required by the devices may be exchanged between individual devices and between devices and application servers. Examples of IoT devices include sensors, actuators, smart appliances, and so on. Some IoT devices are subject to limitations on processing power, storage capacity, energy supply, device complexity and/or network connectivity, imposed by their operating environment or situation; these devices may consequently be referred to as constrained IoT devices (or simply constrained devices).

The constrained nature of many IoT devices has prompted the design and implementation of new protocols and mechanisms. The Constrained Application Protocol (CoAP), as defined in RFC 7252 (produced by the Internet Engineering Task Force, IETF, available at https://tools.ietf.org/html/rfc7252 as of 26 Feb. 2021), is one example of a protocol designed for IoT applications in constrained nodes and constrained networks. CoAP provides a request for information-response based RESTful communication architecture (using Representational State Transfer, REST, architecture) between constrained nodes or between constrained nodes and nodes on the Internet. CoAP can be integrated with the web and web services by translating CoAP messages to HTTP. CoAP variants like Lightweight Machine to Machine Protocol (LWM2M) are becoming increasingly popular in order to manage devices in a RESTful fashion. LwM2M provides a simple mechanism for device management of IoT Devices. It provides interfaces for information reporting, service enablement, firmware updates and other device management services.

In addition or alternatively to CoAP transmissions, some devices may support Unstructured Supplementary Services Data (USSD) transmissions. USSD allows for the transmission of information via a network, for example a 2G, 3G or 4G network. USSD communications provide real time connection during a session, with each message containing up to 182 alphanumeric characters. USSD supports interactive services between a device and applications hosted by an operator. The messages are composed of digits and the #, * keys, and allow users to easily and quickly get information/access services from the operator. A typical USSD message starts with a * followed by digits which indicate an action to be performed or are parameters; each group of numbers is typically separated by a *, and the message is typically terminated with a #. The USSD gateway in turn can interact with external applications based on the USSD command. When a user sends a message to an operator network, it is typically received by a computer dedicated to USSD. The response of the computer response is sent back to the phone, generally in a basic format that can easily be seen on the phone display. Messages sent over USSD are not defined by any standardization body, so each operator can implement whatever is most suitable for its customers.

One of the difficulties impeding the implementation of data-initiated emergency sessions is the extreme diversity of protocols and operation modes of the devices (for example, IoT devices). Solution which require that a device is provisioned with a valid Subscriber Identity Module (SIM) card and utilise radio connectivity may not be suitable for the broad range of devices which may wish to contact emergency services (for example: alarms, meters, sensors, connected vehicles, and so on) and also may not support the multiplicity of emergency indications that could be signalled. Existing configurations also cannot make full use of the protocols and services available in the devices, which may be of use to emergency services when assessing an emergency situation and seeking to collect additional information. Device data collection capabilities are not available to the emergency services unless they have access to the device attached application server, or IoT platform that terminates the devices connection, which is typically not the case.

### SUMMARY

It is an object of the present disclosure to computing devices, methods and systems for enabling emergency data communications with emergency control centres via Radio Access Networks (RAN).

Embodiments provide computing devices, systems, methods and computer programs which at least partially address one or more of the challenges discussed above.

According to an aspect of the present disclosure, there is provided a computing device operable to establish a data connection with an emergency control centre via a RAN. The computing device comprises processing circuitry operable to detect sensor data indicative of an emergency situation, and initiate transmission of an access request, requesting establishment of a connection, to a RAN node of the RAN. The processing circuitry is further operable to, in response to notification of an established connection, initiate transmission of an attach request requesting establishment of a data connection with an emergency control centre. The attach request includes an indicator that the attach request relates to the emergency situation. The computing device may support the formation of connections between computing devices and emergency control centres without the use of voice communication, and may also allow prioritisation of requests and messages relating to emergency situations by RANs. The computing device may be provisioned before deployment with emergency configuration information for use in connecting to the emergency control centre.

Additionally or alternatively, the computing device may request emergency configuration information for use in connecting to the emergency control centre when connected to the RAN, and/or when data indicative of an emergency situation is detected. The computing device may thereby obtain emergency configuration information in a variety of different ways, thereby increasing the versatility and robustness of the system.

The access request itself may include an emergency indication, thereby potentially allowing the access request to be prioritised by the RAN.

Once the data connection with the emergency control centre has been established, the computing device may exchange data with the emergency control centre, wherein each data exchange message between the computing device and emergency control centre may comprise an attribute indicating to the RAN that the data exchange message relates to an emergency situation. Indicating to the RAN that the data exchange message relates to an emergency situation allows the RAN to handle the data exchange message appropriately, for example, by prioritising the sending of the message.

A system may comprise the computing device, and may further comprise the emergency control centre. The emergency control centre may be configured, when a data connection with the computing device is established, to use the data connection to request sensor data from the computing device. In particular, the emergency control centre may be configured to use the data connection to trigger sensor readings. In this way, the emergency control centre may obtain useful information from the computing device allowing the emergency situation to be handled more effectively.

According to another aspect of the present disclosure, a method in a computing device for establishing a data connection with an emergency control centre via a RAN is provided. The method comprises detecting sensor data indicative of an emergency situation, and initiating transmission of an access request, requesting establishment of a connection, to a RAN node of the RAN. The method further comprises, in response to notification of an established connection, initiating transmission of an attach request requesting establishment of a data connection with an emergency control centre. The attach request includes an indicator that the attach request relates to the emergency situation. The method may provide some or all of the advantages discussed above in the context of the computing device.

According to a further aspect of the present disclosure, a computer program is provided. The computer program comprises instructions which, when executed on at least one processor, cause the at least one processor to carry out a method according to an embodiment of the method in a computing device for establishing a data connection with an emergency control centre via a RAN.

According to a further aspect of the present disclosure, a carrier containing an embodiment of the computer program is provided. The carrier comprises one of an electronic signal, optical signal, radio signal, and a computer readable storage medium.

According to a further aspect of the present disclosure, a computer program product comprising non-transitory computer readable media is provided. The non-transitory computer readable media have stored thereon an embodiment of the computer program.

### BRIEF DESCRIPTION OF THE DRAWINGS

The disclosure is described, by way of example only, with reference to the figures, in which:

FIG. 1 is a flow chart illustrating a method performed by a computing device in accordance with embodiments of the disclosure;

FIGS. 2A and 2B are schematic diagrams of computing devices in accordance with embodiments of the disclosure;

FIGS. 3A (I and II) and 3B (I and II) are sequence diagrams showing examples of attachment procedures in accordance with embodiments of the disclosure; and

FIGS. 4A and 4B are a further sequence diagram showing an example of communications between a computing device and an emergency control centre via a RAN when an emergency situation is detected in accordance with an embodiment of the disclosure.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement Embodiments of the present disclosure may provide means for data connections to be established between computing devices (such as IoT devices) and emergency control centres via Radio Access Networks. Embodiments may also enable emergency services to acquire data from computing devices, and may also support some element of control of the computing devices by emergency services. Accordingly, embodiments may support efficient communications between computing devices and emergency services, including establishing a communication channel between the two in which the only intermediary entities are those forming part of the RAN network, and may also facilitate emergency services in obtaining useful information in critical situations.

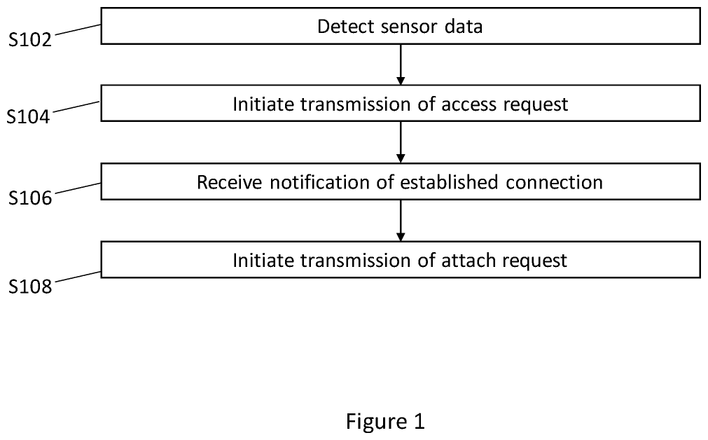

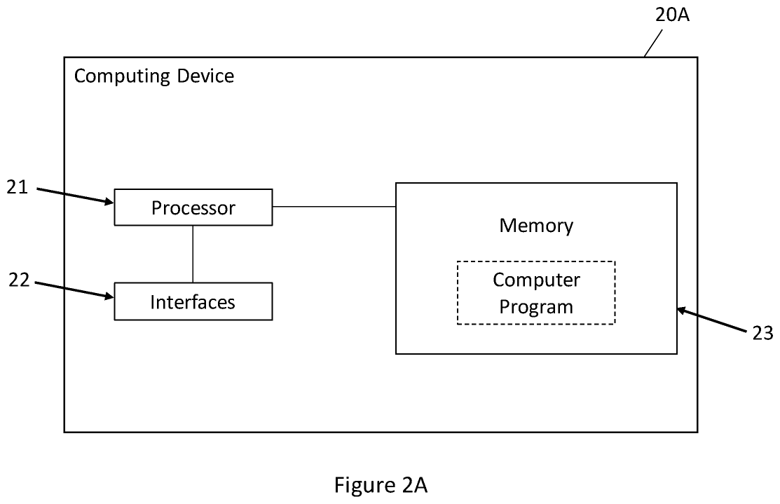

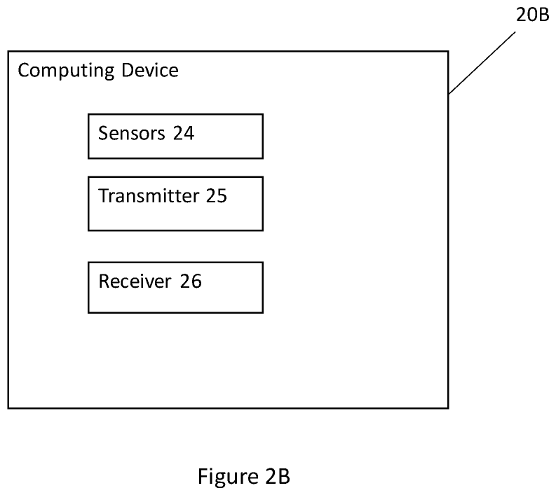

FIG. 1 is a flowchart showing a method according to embodiments for a computing device to establish a data connection, via a RAN, with an emergency control centre. In particular, the method of FIG. 1 allows a computing device that has detected sensor data that may indicate an emergency situation to initiate establishment of a connection to a RAN node. When the connection to the RAN node has been established, the computing device then transmits an attach request requesting establishment of a data connection with the emergency control centre, the attach request including an indicator that it relates to the emergency situation. FIG. 2A and FIG. 2B show computing devices 20A, 20B in accordance with embodiments. The computing devices 20A, 20B may perform the method of FIG. 1.

In step S102 of FIG. 1, the computing device detects sensor data that may indicate an emergency situation. In some embodiments the computing device may itself comprise one or more sensors, for example, the computing device may be an IoT fire alarm comprising thermal sensors, smoke detectors, and so on, and an emergency situation may be indicated when the thermal sensors, smoke detectors and so on indicate a fire. In a further example, the computing device may be a connected vehicle comprising accelerometers, and an emergency situation may be indicated by acceleration readings indicative of a vehicle collision. Those skilled in the art will appreciate that embodiments may utilise a wide variety of different sensor types, detecting a wide variety of emergency situations. Additionally or alternatively, the computing device may receive data from one or more sensors that do not form part of the computing device. The detection of the sensor data may be performed, for example, by the processor 21 of computing device 20A running a program stored on the memory 23 and utilising the interfaces 22 (which may include one or more sensors), or may be performed by the sensors 24 of computing device 20B.

In response to detecting sensor data that may indicate an emergency situation, the computing device initiates transmission of an access request requesting establishment of a connection to a RAN node of the RAN, as shown in step S104. The computing device may itself transmit the access request, or may initiate transmission by sending instructions to a transmitter to transmit the request. The nature of the access request is at least partially dependent on the capabilities and configurations of the RAN node (and RAN) and computing device. In some embodiments, the computing device may send a random access request; alternatively where a deterministic access system is used, the access request may not be a random access request. Essentially, the computing device initiates transmission of a network access request of a form that is compatible with the RAN to which the computing device seeks to establish a connection. The transmission of the access request may be initiated, for example, by the processor 21 of computing device 20A running a program stored on the memory 23 and utilising the interfaces 22 (which may include one or more transmitters), or may be performed by the transmitter of computing device 20B.

In some embodiments, the access request may itself comprise an emergency indication. As an example of this, a pre-configured indicator such as an emergency random access preamble may be included in the access request to indicate that the request relates to an emergency situation. Upon receiving an access request including an emergency indicator, the network may prioritise the access request, for example.

In response to the access request, the RAN node of the RAN establishes a connection and responds with notification of an established connection to the computing device, as shown in step S106. The notification of the connection may be received, for example, by the processor 21 of computing device 20A running a program stored on the memory 23 and utilising the interfaces 22 (which may include one or more receivers), or may be performed by the receiver 26 of computing device 20B.

Upon receipt of the notification of an established connection, the computing device then requests establishment of a data connection with the emergency control centre using an attach request. The attach request includes an indicator that the attach request relates to the emergency situation. The initiation of the transmission of the attach request is shown in step S108 of FIG. 1. The transmission of the attach request may be initiated, for example, by the processor 21 of computing device 20A running a program stored on the memory 23 and utilising the interfaces 22 (which may include one or more transmitters), or may be performed by the transmitter 25 of computing device 20B. The attach request may be prepared using emergency configuration information that details how the computing device may connect to the emergency control centre; this emergency configuration information may be provided to the computing device in one (or more) of a number of different ways.

The content of the configuration information may be determined in part by the capabilities of the computing device. In some embodiments, the computing device may be capable of acting as an endpoint for Internet Protocol (IP) communications. Where the computing device can act as an endpoint for IP communications, the computing device may use configuration information comprising an IP address for the emergency control centre; this information may also be present in the configuration information when the computing device cannot act as an endpoint for IP communications, but in this situation the computing device may not be able to make use of the IP address. In some embodiments the IP address provided may be used to contact the emergency control centre but may not actually be the IP address of the emergency control centre; instead the IP address may be that of a further component or system, for example, a forwarding service used to protect the emergency control centre from Directed Denial of Service (DDoS) attacks. The configuration information may also specify a bearer setup to be used for connecting to the emergency control centre, and may include specifications of which communication protocol to use, what data serialization format to use, authentication information such as how to establish a secure connection between the computing device and emergency control centre (including potentially security credential information or certificate information), and so on.

In some embodiments, the emergency configuration information may be provided to the computing device before the computing device is deployed, for example, the emergency configuration information may be installed during the manufacture of the computing device. In order to provide the emergency configuration information to the computing device, a SIM card or soft-SIM (aka eSIM) may be provided with the connectivity details to reach the emergency control centre. The SIM card or soft-SIM may include details such as a specific IP address to map an emergency service call to, or a specific bearer setup, or additional information that is forwarded during the connection request messaging exchange (for example a flag indicating emergency in the Connection Request message from the device) that helps the network to identify the type of call and direct the device to either obtain the configuration for the emergency call or connect directly to the emergency control centre. The SIM configuration can be used when the device is able to reach the operator network which has provided the SIM card or soft-SIM or has roaming agreement with such operator, otherwise the configuration may be consider invalid and the computing device may use other options to establish connection.

In some embodiments, the emergency configuration information may be requested by the computing device when connected to the RAN; the request for the emergency configuration information may be sent the first time the computing device connects to the RAN, and/or when the computing device connects to the RAN when data indicative of an emergency situation is detected (that is, when the access request of step S102 is sent). In some embodiments, the computing device may indicate an emergency situation after a regular attachment to the network by using a pre-configured or established USSD code (for example, **112**). After receiving the emergency indication, the RAN may provide the configuration details to allow the computing device to contact the emergency control centre. An example of configuration details which may be provided is an Access Point Name (APN) configuration, which may serve as a gateway to forward the emergency communication towards the emergency control centre. The APN may apply rules such as discrimination of traffic based on the type of devices or belonging to a group, upper layer protocols used, time of the contact, and so on. The configuration details may also be provided as part of the control messaging exchange after the connection request, where the configuration to contact the emergency control centre can be provided to the computing device in a dedicated control message (using for example Radio Resource Control, RRC) or attached to one of the existing reply messages during the connection procedure. The configuration information may then be used by the computing device in similar way to the APN.

In embodiments wherein the computing device do not support, or for some other reason do not use, IP connectivity, a proxied IP address may be established (for example, by a Service Capability Exposure Function, SCEF, or Network Exposure Function) that would represent the computing device from the viewpoint of the servers of the emergency control centre. Subsequent communications sent by the computing device would be directly forwarded to the emergency control centre with IP connectivity, and replies from the emergency control centre may be directed to the IP address allocated by the network. The network would then strip the IP and transport protocols from the messages (IP tunnelling) and transmit them to the device using the radio network protocols as it is done with any other non-IP traffic tunnel to IP servers.

In any of the above embodiments, the computing device may periodically request updated emergency configuration information to ensure that it is aware of any updates; the period may be determined by a network operator or emergency control centre, for example. Additionally or alternatively, the emergency control centre or network operator may push an emergency configuration information update when necessary (that is, when the information changes). The computing device may make use of a dedicated control message to signal an emergency situation, or may use USSD codes as discussed above. An update may be triggered if the configuration information to contact the emergency control centre is not up to date or is invalid. The computing device may trigger an update when an error is received upon attempting to use the configuration information, another option is that the network may send such configuration proactively if such error is detected.

The attach request may be transmitted in any suitable format, determined largely by the capabilities of the computing device. Where the computing device can act as an endpoint for IP communications, the access request may request establishment of an IP connection to a RAN node, and the attach request may then be transmitted as an IP communication using this established IP connection. Alternatively, the attach request may be transmitted as a non-IP communication; a non-IP communication may be utilised even in situations where the device is IP capable but has not been used to form the established connection. Any suitable non-IP communication form may be used, an example of a non-IP communication format which is particularly well suited (due to the robustness of the format and broad applicability) is USSD communication as discussed above.

Generally, where IP communications are used by the computing device, the connection with the emergency control centre is an IP connection. Equally, where non-IP communications are used by the computing device, communications with the emergency control centre typically pass via a proxy server that forms part of the RAN, wherein the proxy server receives the non-IP communications from the computing device and passes the communications on to the emergency control centre in the form of IP communications (and performs the reverse process for communications from the emergency control centre to the computing device). However, in some embodiments, an emergency data object may be agreed between the network and the computing device. The emergency data object may be an emergency flag that used by a gateway connecting the computing device to the RAN (such as a Service Capability Exposure Function, SCEF, or Network Exposure Function, NEF) to interpret the data. The emergency data object may indicate the emergency status of messages using a UE initiated non-IP connection. If the RAN has the capability of parsing non-IP communications, then the RAN may be configured to detect an emergency flag on a message and forward the message to the emergency control centre without the use of a proxy server.

Once the connection between the computing device and the emergency control centre has been established, the computing device and the emergency control centre may then use the connection to exchange data. In order to ensure that these data exchanges are not unduly delayed on passage through the RAN, the data exchange messages may comprise an attribute indicating to the RAN that the data exchange message relates to an emergency situation. The attribute may be a flag on the messages, the formatting of the message, or any suitable indicator to the RAN of the emergency situation. Using this information, the RAN may, for example, prioritise the sending of the messages over non-emergency messages using the RAN (that is, the messages relating to an emergency situation may be given a higher priority by the RAN than other non-emergency messages).

In some embodiments the attach request may be a request to establish a secure data connection with the emergency control centre (wherein any suitable security protocols, such as encryption, may be used). Where this request is satisfied and a secure data connection is established between the computing device and the emergency control centre, the data exchange between the computing device and the emergency control centre may then be secure. The secure data connection may be used by the emergency control centre to receive sensor data from the computing device; in some embodiments the emergency control centre may request sensor data from the computing device, and may trigger the taking of sensor readings by or via the computing device (the results of which may subsequently be sent to the emergency control centre). A non-secure data connection may also be used for the requesting, sending and triggering of sensor data as discussed above, although this may be less preferable where the sensor data may comprise sensitive information.

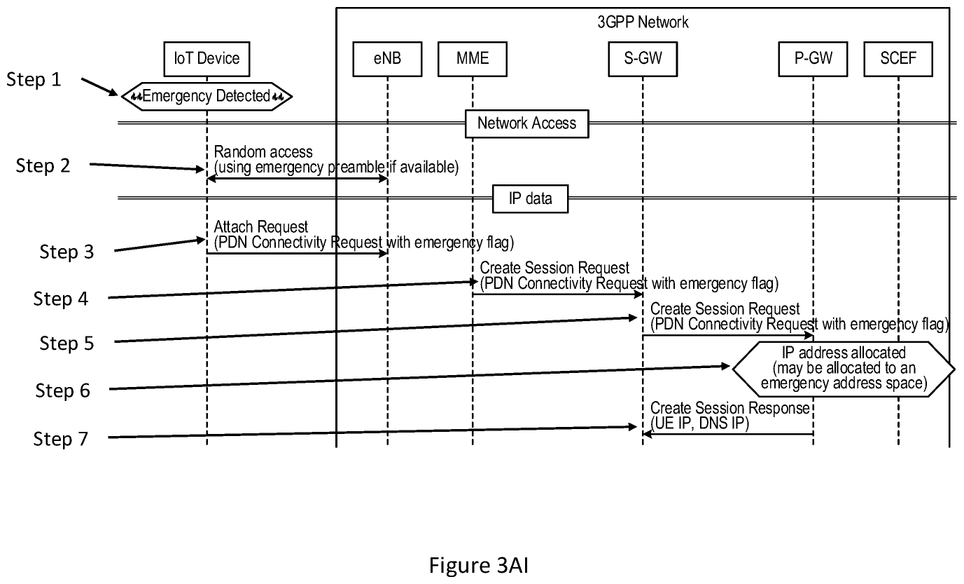

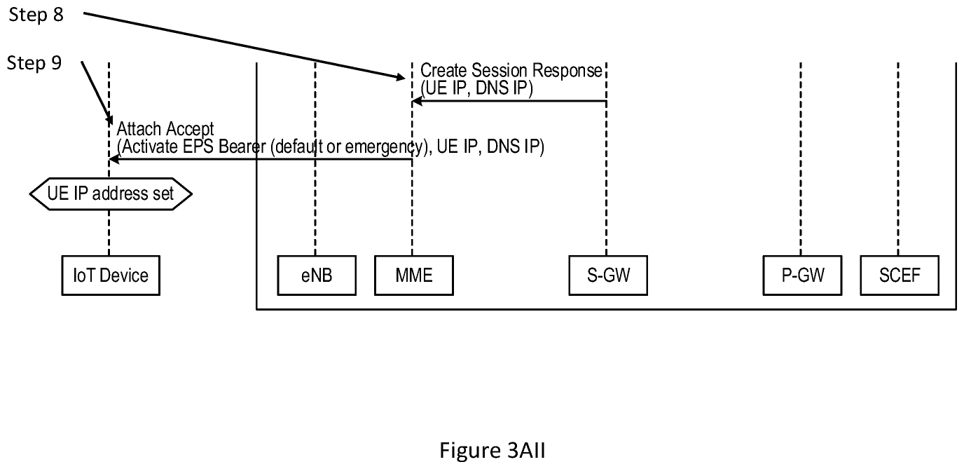

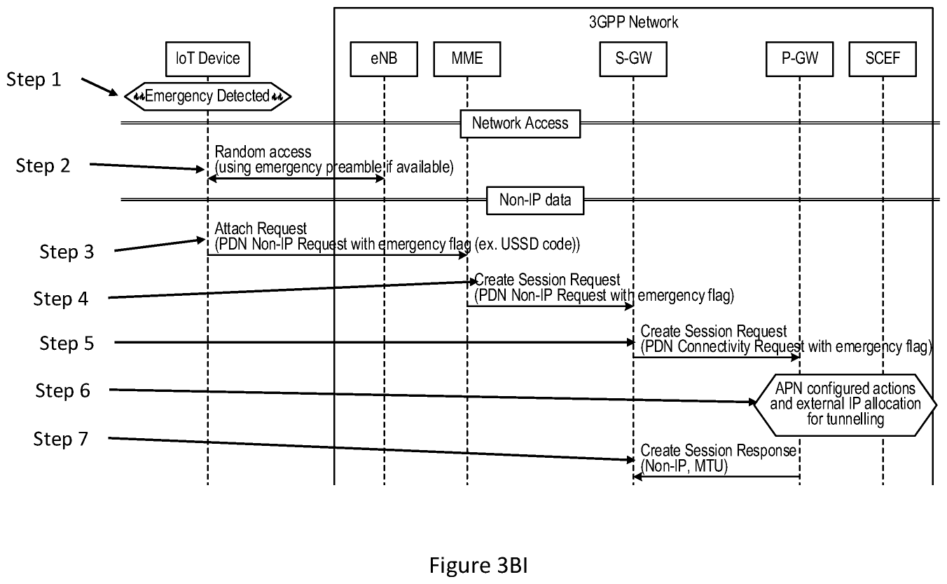

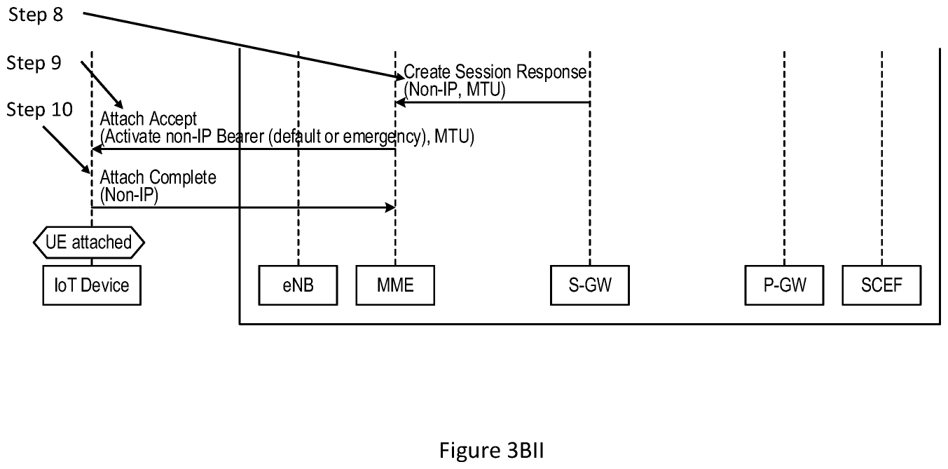

FIG. 3A and FIG. 3B (collectively referred to as FIG. 3) are sequence diagrams showing examples of procedures for establishing a data connection with an emergency control centre via a RAN, in accordance with embodiments. FIG. 3A, which is divided into 3AI and 3AII, shows a procedure wherein the computing device (here an IoT device) utilises IP capabilities. FIG. 3B is divided into 3BI and 3BII and shows a procedure wherein the computing device (again, an IoT device) does not utilise IP capabilities.

In step 1 of FIG. 3 the IoT device detects sensor data indicative of an emergency (in this example, a fire). At step 2 of FIG. 3, the IoT device transmits an access request, here a random access request, to a base station of a network, and completes an access procedure with the base station. In the embodiment illustrated in FIG. 3, the network is a 3^{rd} Generation Partnership Project (3GPP) network and the base station is an enhanced NodeB (eNB). Steps 1 and 2 are the same for the examples of FIG. 3A and FIG. 3B; the methods diverge at step 3.

At step 3 of FIG. 3A, the IoT device sends an attach request; in the embodiment illustrated in FIG. 3A the attach request is a Packet Data Network (PDN) connectivity request using IP connectivity. The attach request includes an indicator that the request relates to an emergency; in the embodiment illustrated in FIG. 3A this is a flag on the message. At step 4 of FIG. 3A, a Mobile Management Entity (MME) sends a session creation request, based on the attach request, to a serving gateway (S-GW), then at step the S-GW forwards the session creation request to a PDN gateway (P-GW). At step 6 the IoT device is allocated an IP address and the session is created, then at steps 7 and 8 the session creation response is sent back via the S-GW to the MME. At step 9 the MME informs the IoT of the attachments acceptance and an Evolved Packet System (EPS) bearer is established to provide connectivity between the IoT device and the P-GW. The access procedure is then complete.

The method according to the embodiment shown in FIG. 3B is similar to that shown in FIG. 3A. As mentioned above, steps 1 and 2 are the same. At step 3 of FIG. 3B, the IoT device sends an attach request. In the embodiment illustrated in FIG. 3A the attach request is a Packet Data Network (PDN) connectivity request not using IP connectivity, for example, using a USSD code as discussed above. The attach request includes an emergency flag. As in the case of FIG. 3A, in steps 4 and 5 a session creation request is sent to the P-GW. At step 6, an external IP address (external to the IoT device) is allocated. At steps 7 and 8 a session creation response is sent to the MME via the S-GW. Step 9 shows the attachment acceptance being sent back to the IoT device, and then the completion of the procedure at step 10.

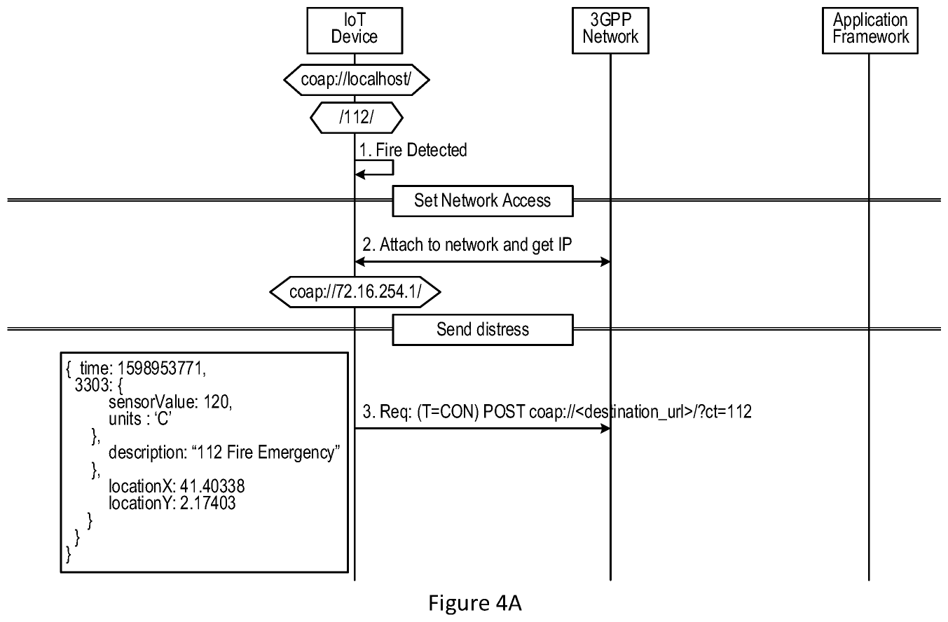

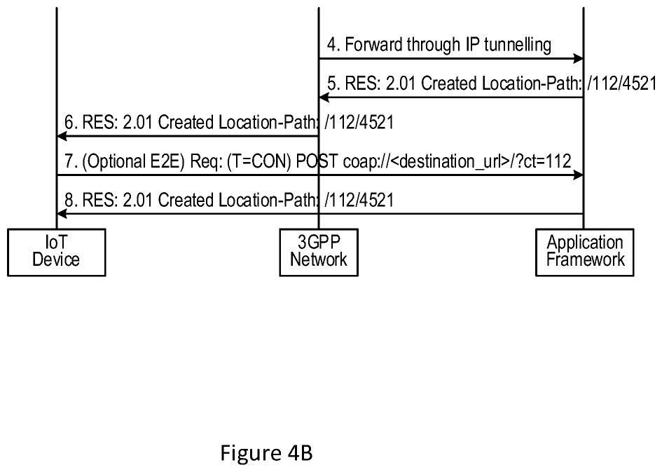

FIG. 4 is a sequence diagram showing an example of communications between a computing device and an emergency control centre via a RAN when an emergency situation (in this case, a fire) is detected, in accordance with an embodiment. In the embodiment shown in FIG. 4, the computing device is an IoT device and the RAN is a 3GPP network. The IoT device incorporates at least one sensor, and is configured to use CoAP. In the embodiment illustrated in FIG. 4, the IoT device is pre-configured with configuration information (indicated as /112/ in FIG. 4) before deployment, for example, during manufacture. In alternative embodiments the emergency configuration may be provided in a different way, as discussed above. The IoT device in FIG. 4 is IP capable; as explained above in some embodiments computing devices that are not IP capable may be used.

At step 1 of FIG. 4, the IoT device detects sensor data indicative of a fire. In response to the detection, the IoT device sends an access request and attach request, resulting in the attachment of the IoT device to the network; any of the procedures discussed above (such as those shown in FIG. 3A) may be used to attach the IoT device to the network (see step 2). The procedure results in an IP address that the network uses to connect to the IoT device (here 72.16.254.1). The IoT device uses IP connectivity, so the IP address is that of the IoT device. In embodiments where the IoT device uses non-IP connectivity, the network allocates an IP address for a proxy server, which tunnels the message exchanges to and from the IoT device as regularly done for non-IP communication.

At step 3, the IoT device exchanges data with the emergency control centre, in particular the IoT device sends a distress message. In the example shown in FIG. 4, the IoT device uses the CoAP to send a POST request to a destination Uniform Resource Locator (URL) of the emergency control centre. An example of a distress message that may be sent, using pseudocode, is shown below.

| | |
|---|---|
| { | time: 1598953771, |
| | 3303: { |
| | ′0′: { |
| | sensorValue: 120, |
| | units : ′C′ |
| | }, |
| | ′1′: { |
| | description: “112 Fire Emergency” |
| | }, |
| | ′18′: { |
| | locationX: 41.40338 |
| | locationY: 2.17403 |
| | }}} |

This example message includes a timestamp (“time”), the id of the IoT device (“3303”), an indication that a temperature of 120 degrees centigrade has been detected (“sensorValue: 120, units: ‘C’”), the resulting identification of a fire “description: “112 Fire Emergency”), and the location at which the fire has been detected (locationX and locationY coordinates).

The POST request is also of the type CON (confirmable) which acts as a confirmation of delivery over User Datagram Protocol (UDP) as is used in IP, if no response is received from the emergency control centre the IoT device will retransmit. A non-IP device would only send the message content to the proxy server.

At step 4, the network forwards the message to the emergency control centre, in the embodiment shown in FIG. 4 IP tunnelling is used to forward the message. Subsequently, at step 5, the emergency control centre sends a response (RES) message; in the example shown in FIG. 4, the emergency control centre provides a location to be used by the IoT device for subsequent communications (Created Location-Path: /112/4521). The response message is forwarded to the IoT device by the network at step 6. Subsequent messages may be sent by the IoT device directly to the emergency control centre (using End to End, E2E, communication) as shown in step 7, and as acknowledged in the response message of step 8.

Embodiments of the present disclosure provide systems for establishing data connections between computing devices and emergency control centres. Embodiments may therefore support connections between computing devices and emergency control centres without the requirement for voice communication involvement, and may also support the transfer of sensor information between computing devices and emergency control centres. Delays in providing notification of an emergency situation to emergency control centres may thereby be avoided, and improved information may be available to emergency control centres to allow emergency situations to be efficiently addressed.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1.-36. (canceled)

37. A method in a computing device for establishing a data connection with an emergency control center via a Radio Access Network, RAN, the method comprising:
detecting sensor data indicative of an emergency situation;
initiating transmission of an access request, requesting establishment of a connection, to a RAN node of the RAN; and
in response to notification of an established connection, initiating transmission of an attach request, requesting establishment of a data connection with an emergency control center wherein the attach request includes an indicator that the attach request relates to the emergency situation.

38. The method of claim 37, further comprising provisioning the computing device before deployment with emergency configuration information for use in connecting to the emergency control center.

39. The method of claim 37, further comprising requesting, by the computing device, emergency configuration information when connected to the RAN.

40. The method of claim 37, further comprising requesting, by the computing device, emergency configuration information when data indicative of an emergency situation is detected.

41. The method of claim 38, wherein the emergency configuration information comprises at least one of:
an Internet Protocol, IP, address for the emergency control center;
a message format for use in contacting the emergency control center; authentication information.

42. The method of claim 37, wherein the access request comprises an emergency indication.

43. The method of claim 37, wherein the attach request is transmitted as an Internet Protocol, IP, communication via the established connection, and a data connection with the emergency control center is established via the established connection, wherein the established connection is an IP connection.

44. The method of claim 37, wherein the attach request is transmitted as a non-Internet Protocol, non-IP, communication, and a connection with the emergency control center is established.

45. The method of claim 44, wherein the non-IP communication is an Unstructured Supplementary Services Data, USSD, communication.

46. The method of claim 37, wherein once the data connection with the emergency control center has been established, data is exchanged with the emergency control center, wherein each data exchange message between the computing device and emergency control center comprises an attribute indicating to the RAN that the data exchange message relates to an emergency situation.

47. The method of claim 37, wherein the request to establish a data connection with emergency control center is a request to establish a secure data connection.

48. The method of claim 37, wherein when the secure data connection with the emergency control center is established, a secure data exchange with the emergency control center is performed, wherein the emergency control center obtains sensor data from the computing device in the secure data exchange.

49. The method of claim 37, wherein the computing device is an Internet of Things, IoT, device.

50. The method of claim 37, wherein the computing device comprises one or more sensors.

51. The method of claim 38, wherein when a data connection with the computing device is established, the emergency control center uses the data connection to request sensor data from the computing device.

52. The method of claim 51, wherein the emergency control center uses the data connection to trigger sensor readings.

53. A computing device operable to establish a data connection with an emergency control center via a Radio Access Network, RAN, the computing device comprising processing circuitry operable to:
detect sensor data indicative of an emergency situation;
initiate transmission of an access request, requesting establishment of a connection, to a RAN node of the RAN; and
in response to notification of an established connection, initiate transmission of an attach request requesting establishment of a data connection with an emergency control center wherein the attach request includes an indicator that the attach request relates to the emergency situation.

54. A computer program product comprising non transitory computer readable media having stored thereon a computer program comprising instructions which, when executed on at least one processor, cause the at least one processor to carry out a method according to claim 37.
